(19) United States
(12) Patent Application Publication
(10) Pub. No.: US 2023/0146348 A1
(43) Pub. Date: May 11, 2023

(54) ENTERPRISE USER-BASED METHOD AND SYSTEM FOR SIMPLIFIED PDF DOCUMENT ELECTRONIC SIGNATURE

(71) Applicant: Fujian Foxit Software Development Joint Stock Co., Ltd., Fuzhou, Fujian (CN)

(72) Inventors: Kewang YU, Fuzhou, Fujian (CN); Yuqian XIONG, Fuzhou, Fujian (CN)

(21) Appl. No.: 17/915,244

(22) PCT Filed: Mar. 19, 2021
(86) PCT No.: PCT/CN2021/000047

§ 371 Date: Sep. 28, 2022

(30) Foreign Application Priority Data
Apr. 17, 2020 (CN) 202010308052.0

(51) Int. Cl. H04L 9/32; G06F 21/64

(52) U.S. Cl. CPC H04L 9/3247; G06F 21/64; H04L 9/3263

(57) ABSTRACT

Provided is an enterprise user-based method and system for a simplified PDF document electronic signature. The method comprises: an electronic signature system is configured to link up with an enterprise account system, such that an enterprise user automatically logs in to the electronic signature system of a server after logging in to an operating system; a signature style is created and signing is carried out by using a client; and the server performs digital certificate encryption on a signed document summary, and on the basis of the foregoing, a final PDF document is generated on the client. In the solution of the present invention, by linking up an enterprise account and a signature system, an electronic signature process of a PDF document may be greatly simplified, the signing experience of an enterprise user is as close as possible to a written signing experience, and the present invention is simple and efficient.

### TECHNICAL FIELD

The present disclosure relates to the field of document processing and electronic signature, and more particularly, to an enterprise user-based method and system for simplifying an electronic signature process in PDF document encryption or processing.

### BACKGROUND

Electronic signature refers to data contained in a data message in an electronic form and attached for identifying a signer's identity and indicating that the signer approves the content therein. Generally speaking, an electronic signature is a signature of an electronic document in an electronic form through a cryptographic technology, not just a digital image of a written signature. It is an important means of guaranteeing the data security of electronic documents, e.g., electronic signatures on confidential documents or important contract documents. An electronic signature system generally adopts a PDF document format to implement an electronic signature function.

The electronic signature has two basic functions: identifying a signer, and indicating the signer's approval of the content. In the traditional electronic signature system, when an initiator, that is, a person who initiates a signature, allows another person to sign a signature onto a PDF document after initiating the signature, that is, only one other person signs the document, the following six steps are required:

(1) registering an account in an electronic signature system;

(2) logging in to the electronic signature system;

(3) uploading, by the initiator, the PDF document to the electronic signature system;

(4) creating, by the initiator, an envelope in the electronic signature system, and designating a signature position;

(5) using, by a signer, a signature tool in the electronic signature system to sign at the designated signature position based on the envelope; and

(6) downloading a final signed PDF document.

When the user wants to complete the self-signature of a PDF document, that is, only the user himself signs the document, at least the following six steps are required:

(1) registering an account in the electronic signature system;

(2) logging in to the electronic signature system;

(3) uploading the PDF document to the electronic signature system;

(4) creating an envelope in the electronic signature system;

(5) signing a signature by using a signature tool in the electronic signature system based on the envelope; and

(6) downloading a final signed PDF document.

In the prior art, however, in order to implement the above basic functions and functions related to the signature process, a traditional electronic signature system generally defines an additional set of data structures to describe data related to these functions. This set of data structures is generally referred to as an envelope in the electronic signature system, that is, the envelope in the above steps. The envelope is used to describe data related to the electronic signature function, including: a document, a signer, a signature order, a signature position, a signature type (i.e., full signature and abbreviated signature), and fields (i.e., date, email, company name, etc.) that need to be filled before signature, and the like. An envelope needs be created first each time the user initiates a signature process in the electronic signature system.

This manner is complicated and requires additional creation of envelopes, which consumes a lot of system resources. Therefore, seeking a safe, concise and efficient electronic signature method has become an urgent problem to be solved in the market.

### SUMMARY

In view of the defects of the prior art, the present disclosure proposes an enterprise user-based method and system for simplifying an electronic signature of a PDF document, which simply system resource consumption under the premise of ensuring the security of electronic signatures and document data. Specifically, the present disclosure provides the following technical solutions.

Firstly, the present disclosure provides an enterprise user-based method for simplifying an electronic signature of a PDF document. The method includes:

step 1: configuring an electronic signature system to link up with an enterprise account system, such that the enterprise user automatically logs in to the electronic signature system of a server after the enterprise user logging in to an operating system;

step 2: selecting, by the server, a signature tool, and creating a signature style;

step 3: acquiring, by a client, the signature style and signing a signature onto the PDF document by using the signature tool;

step 4: generating a document summary corresponding to the signature, and transmitting the document summary to the server;

step 5: performing, by the server, digital certificate encryption on the document summary; and

step 6: generating, by the client, a final signed document based on the document summary encrypted with the digital certificate, and saving the final signed document.

Preferably, the step 5 further includes: recording a log by the server, the log recording interaction information between the client and the server.

Preferably, the electronic signature system links up with the enterprise account system through a JWT standard and a NTLM protocol.

Furthermore, the present disclosure further provides an enterprise user-based method for simplifying an electronic signature of a PDF document. The method includes:

step 1: configuring an electronic signature system to link up with an enterprise account system, such that the enterprise user automatically logs in to the electronic signature system of a server after the enterprise user logging in to an operating system;

step 2: selecting, by the server, a signature tool, and creating a signature style;

step 3: acquiring, by a client, the signature style, and signing a signature onto the PDF document by using the signature tool;

step 4: generating a document summary corresponding to the signature, and transmitting the document summary to the server;

step 5: performing, by the server, digital certificate encryption on the document summary; and

step 6: generating, by the client, a final signed document based on the document summary encrypted with the digital certificate, and saving the final signed document.

Preferably, the electronic signature system links up with the enterprise account system through a JWT standard and a NTLM protocol.

Preferably, the step 3 further includes: extending, by the client, a standard PDF form field of the PDF document in advance, specifically including:

adding a FoxitSign dictionary entry in the standard PDF form field, the FoxitSign dictionary entry using a FoxitSign key as a primary key and having a value containing initiator and/or signer related information;

adding a Signer dictionary entry in the standard PDF form field, the Signer dictionary entry using a Signer key as a primary key and having a value being one piece of signer related information; and the Signer dictionary entry being configured in an interactive form field dictionary.

Preferably, the FoxitSign dictionary entry includes: a character string type entry Endpoint having a value being a service address of a signature service provider; a dictionary type entry Initiator having a value being initiator related information; an array type entry Signers having a value being information related to each signer, where the type of each array element is an indirect object.

Preferably, in the presence of a plurality of signatures and a signature order, the FoxitSign dictionary entry may further include a Boolean type entry Sort having a value indicating whether a signature order exists.

Preferably, the dictionary entry Initiator includes: a character string type entry Name having a value being a name of the initiator; and a character string type entry Email having a value being an email address of the initiator.

Preferably, an entry Signer included in the array type entry Signers include: a name type entry Type having a value being a value of a Signer dictionary entry; a character string type entry Name having a value being a name of the signer; and a character string type entry Email having a value being an email address of the signer.

Preferably, in the presence of a plurality of signers and a signature order, the client determines a signature field to be processed and the signature order according to the signer's login identity by means of the following manners:

step 31: acquiring an email of the current signer;

step 32: traversing all the signer information recorded in the document according to the extended standard PDF form field;

step 33: determining whether the signature order is formulated, if YES, proceeding to step 34, and if NO, proceeding to step 35;

step 34: determining whether each signer having an order priority higher than that of the current signer has signed the signature, if YES, proceeding to step 35, and if NO, exiting; and

step 35: determining whether it is the field to be processed by the current signer, if YES, processing and signing the signature, and if NO, hiding the signature field, or not allowing to operate the signature field.

In another aspect, the present disclosure further provides an enterprise user-based method for simplifying an electronic signature of a PDF document. The system includes:

a client module, used for a user account to log in and acquire a signature style from a server, and used to support signing a signature onto the PDF document by using a signature tool; generate a corresponding document summary after signing the signature, and submit the document summary to the server; and generate a final signed document based on the document summary encrypted with a digital certificate; and a server module, used for configuring an electronic signature system to link up with an enterprise account system, such that the enterprise user automatically logs in to the electronic signature system of the server after the enterprise user logging in to an operating system; and used for creating a signature style; and performing digital certificate encryption on the document summary submitted by the signer, and recording a log.

Preferably, the client module is also used for an initiator to edit a PDF document, write initiator information in the PDF document, create a PDF signature field and a form field, designate a signer, and writing signer information in the PDF document.

In yet another aspect, the present disclosure further provides another enterprise user-based system for simplifying an electronic signature of a PDF document. The system includes:

a client module, used for a user account to log in and acquire a signature style from a server, and used to determine a signature field of a PDF document to be signed, and support signing a signature onto the PDF document in the signature field by using a signature tool; generate a corresponding document summary after signing the signature, and submit the document summary to the server; and generate a final signed document based on the document summary encrypted with a digital certificate; and a server module, used for configuring an electronic signature system to link up with an enterprise account system, such that the enterprise user automatically logs in to the electronic signature system of the server after the enterprise user logging in to an operating system; creating a signature style; and performing digital certificate encryption on the document summary submitted by the signer, and recording a log.

The client module further includes a form extension module for creating a standard PDF form field, and extending the standard PDF form field.

Preferably, the client module is also used for an initiator to edit a PDF document, write initiator information in the PDF document, create a PDF signature field and a form field, designate a signer, and writing signer information in the PDF document.

Preferably, the client module is also used for designating a signature order, and write signature order information in the PDF document.

Preferably, the form extension module extending the standard PDF form field specifically includes:

adding a FoxitSign dictionary entry in the standard PDF form field, the FoxitSign dictionary entry using a FoxitSign key as a primary key and having a value containing initiator and/or signer related information; and adding a Signer dictionary entry in the standard PDF form field, the Signer dictionary entry using a Signer key as a primary key and having a value being one piece of signer related information; and the Signer dictionary entry being configured in an interactive form field dictionary.

In yet another aspect, the present disclosure further provides an enterprise user-based device for simplifying an electronic signature of a PDF document. The device at least includes a processor and a memory, wherein the memory stores an executable instruction therein; and the processor can read the executable instruction in the memory to perform the above-mentioned enterprise user-based method for simplifying the electronic signature of the PDF document.

Compared with the prior art, the technical solution of the present disclosure enables the PDF document to be electronically signed to be directly transferred between users, and users can complete all signature related actions in a PDF editor, thereby eliminating the trouble of additionally uploading the document to the electronic signature system and creating an envelope. The PDF-based signature process can be as close as possible to a written signing experience, and is thus more concise and efficient.

### BRIEF DESCRIPTION OF THE DRAWINGS

FIG. 1 is a flowchart of a self-signature of a PDF document from an initiator according to an embodiment of the present disclosure;

FIG. 2 is a flowchart of a signature of a PDF document by another person other than the initiator according to an embodiment of the present disclosure; and

FIG. 3 is a flowchart of a client determining a signature order according to an embodiment of the present disclosure.

### DETAILED DESCRIPTION

The technical solutions in the embodiments of the present disclosure will be clearly and completely described below with reference to the drawings in the embodiments of the present disclosure. Obviously, the described embodiments are only a part of the embodiments of the present disclosure, not all of the embodiments. Based on the embodiments of the present disclosure, all other embodiments obtained by those of ordinary skill in the art without creative efforts shall fall within the protection scope of the present disclosure.

### Embodiment 1

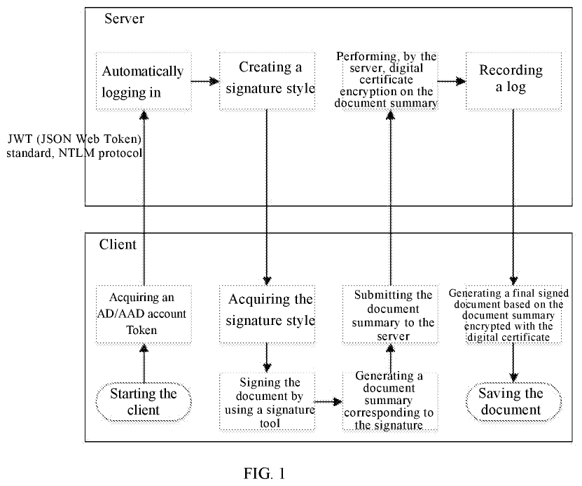

When a user creates a PDF document and the user wants to complete a self-signature 2 of the document, in this embodiment, especially for an enterprise user, the self-signature 2 can be simplified by means of creating an envelope in the traditional electronic signature. For this user self-signature scenario, the step of electronically signing the PDF document can be simplified into two sub-steps, as shown in FIG. 1. The specific method is as follows.

Firstly, data related to the electronic signature function is described based on the PDF document, thereby replacing an envelope.

(1) The document in the envelope is a PDF document that the user is currently reading or editing.

(2) A signer in the envelope is a user who is currently reading the PDF document.

(3) A signature position and a signature type in the envelope mean that the user selects a signature tool to sign in a certain position in the PDF document.

(4) Fields that need to be filled in before signing the signature defined in the envelope can be created and filled in directly with a PDF form tool.

Secondly, in an enterprise environment, an enterprise generally has its own account system, such as an AD or AAD account system. Therefore, the enterprise user already has an account representing his identity, and thus there is no need to register an account in the electronic signature system. More importantly, the electronic signature system can link up with an enterprise account system, such that the enterprise user can log in to the electronic signature system automatically after the enterprise user logging in to an operating system such as Windows with the AD or AAD account, without any manual login operation. Moreover, after automatic login, the electronic signature system can automatically create a signature style for a user with an account name.

With this setting mode, when the enterprise user finally starts a PDF reader to read the PDF document, it only needs two steps to sign the signature:

(1) selecting a signature tool (at this time, a program has automatically created a signature style for the signature tool); and

(2) using the signature tool to sign the signature by clicking a left mouse button at a certain position of the PDF document.

It is found that such a user experience restores the experience of a written signature to the greatest extent, which is equivalent to picking up a pen to sign a written document, and is thus more concise and efficient than the traditional electronic signature system.

On the other hand, in order to implement the innovative method in this embodiment, the entire electronic signature system needs to be divided into two parts: a client and a server. The server mainly focuses on that:

(1) the electronic signature system links up with the enterprise account system through a JWT (JSON Web Token) standard, a NTLM protocol or other technologies;

(2) a signature style is created;

(3) a document summary is encrypted with a digital certificate; and

(4) a log is recorded. The server needs to record interaction information between the client and the server to facilitate query, tracking, auditing, etc.

The Client Mainly Focuses on that:

(1) the client automatically logs in to the electronic signature system with an AD or AAD account that logs in to Windows; and

(2) the server acquires the signature style from the server and supports signing a signature onto the PDF document by using a signature tool.

After signing the signature, the client needs to generate a document summary corresponding to the signature, and submit the document summary to the server for digital certificate encryption. Then, the client uses the document summary encrypted by the digital certificate returned by the server to generate a final signed document. After the signed document is signed by the digital certificate, the validity of the signature can be verified. If the document has been modified, the signature will be invalid.

In addition, through the above specific description of the method in the scenario of this embodiment, those skilled in the art can also know that this embodiment can also be specifically implemented by an enterprise user-based system for simplifying an electronic signature of a PDF document. In a preferred embodiment, this system includes:

a client module, used for a user account to log in and acquire a signature style from a server, and used to support signing a signature onto the PDF document by using a signature tool; generate a corresponding document summary after signing the signature, and submit the document summary to the server; and generate a final signed document based on the document summary encrypted with a digital certificate; and

a server module, used for configuring an electronic signature system to link up with an enterprise account system, such that the enterprise user automatically logs in to the electronic signature system of the server after the enterprise user logging in to an operating system; and

used for creating a signature style; and performing digital certificate encryption on the document summary submitted by the signer, and recording a log.

Preferably, when the initiator needs to make a specific designation for the signer, the client module may also be used for the initiator to edit a PDF document, write initiator information in the PDF document, create a PDF signature field and a form field, designate a signer, and write signer information in the PDF document. Of course, the preferred embodiment here is only provided as a special case.

### Embodiment 2

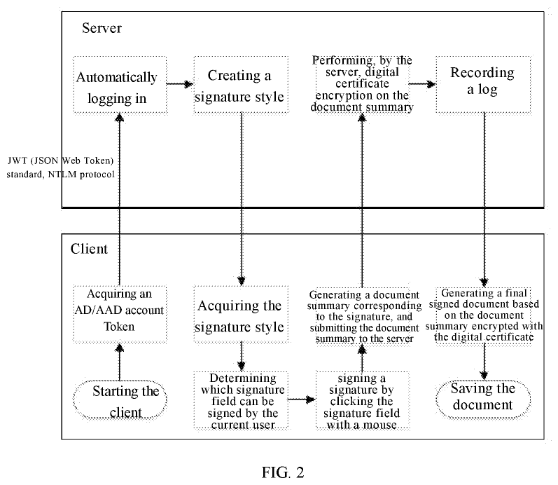

In the prior art, after the initiator initiates a signature, if another person completes the self-signature of a PDF document, that is, only one other person signs the document, the process is complicated (see the description in the background section). In view of this case, in this embodiment, the step of electronically signing the PDF document can be simplified into one step. In conjunction with FIG. 2, the specific method is as follows.

Firstly, data related to the electronic signature function is described based on the PDF document, thereby replacing an envelope in the traditional technologies.

(1) The document in the envelope is a PDF document that the user is currently reading or editing.

(2) A signer in the envelope is a user who is currently reading the PDF document.

(3) It is known that a digital signature field of a PDF form supports placing a signature field in a designated position of the PDF document in advance. The signer only needs to click the signature field with a mouse to sign a digital signature onto the document. Therefore, regarding a signature position and a signature type in the envelope, a digital signature field of a standard PDF form can be extended to support an electronic signature of an electronic signature system.

(4) Fields that need to be filled in before signing the signature defined in the envelope can be created and filled in directly with a PDF form tool.

Secondly, how to extend a standard for the PDF form is determined, such that a user can place the signature field for the electronic signature in the designated position of the PDF document in advance. One entry in the PDF form dictionary (see “Table 8.67 Interactive Form Dictionary Entries” in the PDF standard) needs to be extended:

Extended Entry in Interactive Form Dictionary

| Key | Type | Value |
|---|---|---|
| FoxitSign | Dictionary | (Optional) This dictionary contains information |
| | | about all initiators and signers. If this dictionary |
| | | exists, it means that this PDF document is to be |
| | | electronically signed using the electronic |
| | | signature system. |

FoxitSign Dictionary Entries

| Key | Type | Value |
|---|---|---|
| Endpoint | Character | (Optional) A service address of a signature |
| | string | service provider. |
| Initiator | Dictionary | (Optional) This dictionary contains initiator |
| | | related information. |
| Signers | Array | (Optional) Each element in this array is |
| | | information about each signer. The type of each |
| | | array element is indirect object. |
| Sort | Boolean | (Optional) A Sort value of true indicates that the |
| | | signer has a signature order, and an order of |
| | | elements in “Signers” array represents a signature |
| | | order of signers. A Sort value of false indicates |
| | | that the signer has no signature order. A default |
| | | Sort value is false. |
| | | Note: this embodiment describes a single- |
| | | signature scenario, so there is no issue concerning |
| | | a signature order. Just for illustration, this |
| | | extension is also suitable for multi-signature |
| | | scenarios. That is, in some special scenarios, in |
| | | the presence of signers and a signature order, this |
| | | entry can be extended and determined (the |
| | | specific determination method will be described |
| | | in a specific implementation of this embodiment). |

For the Initiator dictionary entry, the extension is as follows:

Initiator Dictionary Entry

| Key | Type | Value |
|---|---|---|
| Name | Character | (Optional) A name of the initiator. |
| | string | |
| Email | Character | (Optional) An email address of the initiator. |
| | string | |

The Signer dictionary entry is as follows:

Signer Dictionary Entry

| Key | Type | Value |
|---|---|---|
| Type | Name | (Required) The value must be Signer. |
| Name | Character | (Optional) The signer's name. |
| | string | |
| Email | Character | (Optional) The signer's email address. |
| | string | |

In addition, in order to optimize the solution of the present disclosure, one entry in the PDF form field dictionary (see “Table 8.69 Common entries in all form field dictionaries” in the PDF standard) needs to be extended:

Extended Entry in Interactive Form Dictionary

| Key | Type | Value |
|---|---|---|
| Signer | Dictionary | (Optional) Its value is an element in the “Signers” |
| | | array. This value can be filled in when the initiator |
| | | initiates a signature. If the initiator designates this |
| | | value in advance, only the designated signer can |
| | | sign this signature field. This value can also be |
| | | filled in by the signer when signing, and this |
| | | signature field can only be signed by one signer. |
| | | This extension of the PDF form standard is not only |
| | | applicable to the digital signature field of the PDF |
| | | form, but also to other form fields of the PDF form. |

The value of Signer is one piece of the signer related information, such as Type, Name, Email, etc. recorded in this embodiment, that is, the signer's name, address, type, and the like.

Finally, in an enterprise environment, an enterprise generally has its own account system, such as an AD or AAD account system. Therefore, the enterprise user already has an account representing his identity, and there is no need to register an account in the electronic signature system. More importantly, the electronic signature system can be configured to link up with an enterprise account system, such that the enterprise user can log in to the electronic signature system automatically after the enterprise user logging in to an operating system such as Windows with the AD or AAD account, without any manual login operation. Moreover, after automatic login, the electronic signature system can automatically create a signature style for a user with an account name.

To sum up, when an enterprise user finally opens a PDF document with an electronic signature field in a PDF reader, the signature can be completely just by one step, that is, the user can sign the signature with an automatically created signature style by clicking the electronic signature field in the PDF document with a mouse.

It is found that such a user experience restores the experience of a written signature to the greatest extent, which is equivalent to picking up a pen to sign a written document, and is thus more concise and efficient than the traditional electronic signature system.

From a technical point of view, in a specific implementation, in order to implement the innovative method in this embodiment, the entire electronic signature system needs to be divided into two parts: a client and a server. The server mainly focuses on that:

(1) the electronic signature system links up with the enterprise account system through a JWT (JSON Web Token) standard, a NTLM protocol or other technologies;

(2) a signature style is created;

(3) a document summary is encrypted with a digital certificate; and

(4) a log is recorded. The server needs to record interaction information between the client and the server to facilitate query, tracking, auditing, etc.

The Client Mainly Focuses on that:

(1) The client automatically logs in to the electronic signature system with an AD or AAD account that logs in to Windows;

(2) the client acquires a signature style from the server, and supports signing the signature by clicking the electronic signature field in the PDF document with a mouse;

(3) during the signature process, the client needs to determine which signature field can be signed by the current user according to the extension of the PDF form standard, because a signature field may be designated by a signer, or has been signed by other signers; and

(4) after signing the signature, the client needs to generate a document summary corresponding to the signature, and submit the document summary to the server for digital certificate encryption. Then, the client uses the document summary encrypted by the digital certificate returned by the server to generate a final signed document. After the signed document is signed by the digital certificate, the validity of the signature can be verified. If the document has been modified, the signature will be invalid.

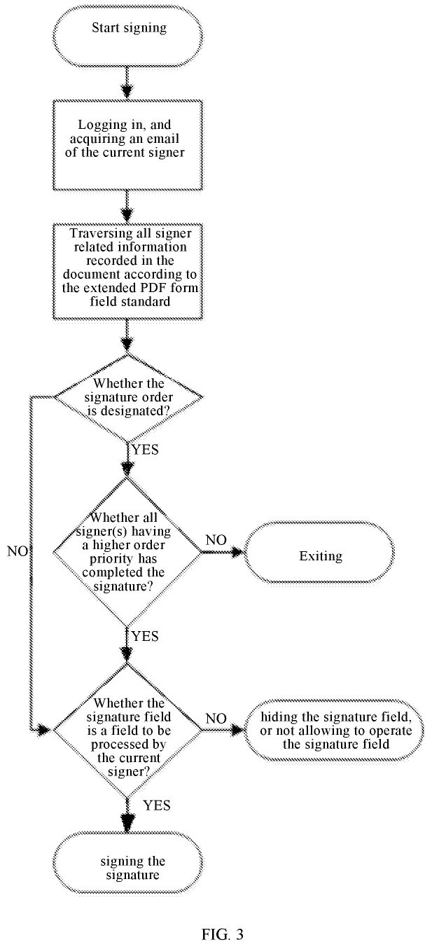

In yet another specific implementation, if a plurality of signers is designated in the presence of a signature order, as shown in FIG. 3, the client determines a signature field to be processed and the signature order according to the signer's login identity, by means of the following specific manners:

step 31: acquiring an email of the current signer;

step 32: traversing all the signer information recorded in the document according to the extended standard PDF form field;

step 33: determining whether the signature order is formulated, if YES, proceeding to step 34, and if NO, proceeding to step 35;

step 34: determining whether each signer having an order priority higher than that of the current signer has signed the signature, if YES, proceeding to step 35, and if NO, exiting; and

step 35: determining whether the signature field is a field to be processed by the current signer, if YES, processing and signing the signature, and if NO, hiding the signature field, or not allowing to operate the signature field.

In yet another specific implementation, those skilled in the art may also know that the present embodiment can also be specifically implemented by an enterprise user-based system for simplifying an electronic signature of a PDF document. This system includes:

a client module, used for a user account to log in and acquire a signature style from a server, and used to determine a signature field of a PDF document to be signed, and support signing a signature onto the PDF document in the signature field by using a signature tool; generate a corresponding document summary after signing the signature, and submit the document summary to the server; and generate a final signed document based on the document summary encrypted with a digital certificate; and

a server module, used for configuring an electronic signature system to link up with an enterprise account system, such that the enterprise user automatically logs in to the electronic signature system of the server after the enterprise user logging in to an operating system; creating a signature style; and performing digital certificate encryption on the document summary submitted by the signer, and recording a log.

The client module further includes a form extension module for creating a standard PDF form field, and extending the standard PDF form field.

Preferably, the client module is also used for an initiator to edit a PDF document, write initiator information in the PDF document, create a PDF signature field and a form field, designate a signer, and write signer information in the PDF document.

Preferably, the client module is also used for designating a signature order, and write signature order information in the PDF document.

Preferably, the form extension module extending the standard PDF form field specifically includes:

adding a FoxitSign dictionary entry in the standard PDF form field, the FoxitSign dictionary entry using a FoxitSign key as a primary key and having a value containing initiator and/or signer related information;

adding a Signer dictionary entry in the standard PDF form field, the Signer dictionary entry using a Signer key as a primary key and having a value being one piece of signer related information; and the Signer dictionary entry being configured in an interactive form field dictionary.

Preferably, the FoxitSign dictionary entry includes: a character string type entry Endpoint having a value being a service address of a signature service provider; a dictionary type entry Initiator having a value being initiator related information; an array type entry Signers having a value being information related to each signer, where the type of each array element is an indirect object.

Preferably, in the presence of a plurality of signatures and a signature order, the FoxitSign dictionary entry may further include a Boolean type entry Sort having a value indicating whether a signature order exists.

Preferably, the dictionary entry Initiator includes: a character string type entry Name having a value being a name of the initiator; and a character string type entry Email having a value is an email address of the initiator.

Preferably, an entry Signer contained in the array type entry Signers include: a name type entry Type having a value being a value of a Signer dictionary entry; a character string type entry Name having a value being a name of the signer; and a character string type entry Email having a value being an email address of the signer.

Except for the above aspects, the technical solution of the present disclosure may also be implemented in a device manner. The device may at least include a processor and a memory, wherein the memory stores an executable instruction therein; and the processor can read the executable instruction in the memory to perform the above-mentioned enterprise user-based method for simplifying the electronic signature of the PDF document in Embodiment 1 or 2. Alternatively, the device may include the enterprise user-based system for simplifying the electronic signature of the PDF document in Embodiment 1 or 2, so as to execute the enterprise user-based method for simplifying the electronic signature of the PDF document as mentioned in Embodiment 1 or 2.

Those of ordinary skill in the art can understand that all or part of the processes in the method of the above embodiment can be implemented by instructing relevant hardware through a computer program which may be stored in a computer-readable storage medium. Upon the execution of this program, the processes of the embodiments of the above-mentioned method may be included. The storage medium may be a magnetic disk, an optical disk, a read-only memory (ROM), a random access memory (RAM) or the like.

It should be eventually noted that: the above embodiments are only used to illustrate the technical solutions of the present disclosure, but not to limit them. Although the present disclosure has been described in detail with reference to the foregoing embodiments, it should be understood by those of ordinary skill in the art that: the technical solutions described in the foregoing embodiments can be still modified, or equivalent replacements to some of the technical features are performed. However, these modifications or substitutions do not make the essence of the corresponding technical solutions deviate from the spirit and scope of the technical solutions of the embodiments of the present disclosure.

1. An enterprise user-based method for simplifying an electronic signature of a PDF document, the method comprising:
step 1: configuring an electronic signature system to link up with an enterprise account system, such that the enterprise user automatically logs in to the electronic signature system of a server after the enterprise user logging in to an operating system;
step 2: selecting, by the server, a signature tool, and creating a signature style;
step 3: acquiring, by a client, the signature style and signing a signature onto the PDF document by using the signature tool;
step 4: generating a document summary corresponding to the signature, and transmitting the document summary to the server;
step 5: performing, by the server, digital certificate encryption on the document summary;
step 6: generating, by the client, a final signed document based on the document summary encrypted with the digital certificate, and saving the final signed document.

2. The method according to claim 1, wherein the step 5 further comprises: recording a log by the server.

3. An enterprise user-based method for simplifying an electronic signature of a PDF document, the method comprising:
step 1: configuring an electronic signature system to link up with an enterprise account system, such that the enterprise user automatically logs in to the electronic signature system of a server after the enterprise user logging in to an operating system;
step 2: selecting, by the server, a signature tool, and creating a signature style;
step 3: acquiring, by a client, the signature style, determining a signature field of a PDF document to be signed, and signing a signature onto the PDF document in the signature field by using the signature tool;
step 4: generating a document summary corresponding to the signature, and transmitting the document summary to the server;
step 5: performing, by the server, digital certificate encryption on the document summary; and
step 6: generating, by the client, a final signed document based on the document summary encrypted with the digital certificate, and saving the final signed document.

4. The method according to claim 3, wherein the step 3 further comprises: extending, by the client, a standard PDF form field of the PDF document in advance, including:
adding a FoxitSign dictionary entry in the standard PDF form field, the FoxitSign dictionary entry using a FoxitSign key as a primary key and having a value containing initiator and/or signer related information;
adding a Signer dictionary entry in the standard PDF form field, the Signer dictionary entry using a Signer key as a primary key and having a value being one piece of signer related information; and the Signer dictionary entry being configured in an interactive form field dictionary.

5. The method according to claim 4, wherein the FoxitSign dictionary entry comprises: a character string type entry Endpoint having a value being a service address of a signature service provider; a dictionary type entry Initiator having a value being initiator related information; an array type entry Signers having a value being information related to each signer, where the type of each array element is an indirect object.

6. The method according to claim 5, wherein the dictionary entry Initiator comprises: a character string type entry Name having a value being a name of the initiator; and a character string type entry Email having a value being an email address of the initiator.

7. The method according to claim 5, wherein an entry Signer contained in the array type entry Signers comprise: a name type entry Type having a value being a value of a Signer dictionary entry; a character string type entry Name having a value being a name of the signer; and a character string type entry Email having a value being an email address of the signer.

8. The method according to claim 5, wherein in the presence of a plurality of signatures and a signature order, the FoxitSign dictionary entry can further comprise a Boolean type entry Sort having a value indicating whether a signature order exists, and in the step 3, the client determines a signature field to be processed and the signature order according to the signer's login identity, by means of the following manners:
step 31: acquiring an email of the current signer;
step 32: traversing all the signer information recorded in the document according to the extended standard PDF form field;
step 33: determining whether the signature order is formulated, if YES, proceeding to step 34, and if NO, proceeding to step 35;
step 34: determining whether each signer having an order priority higher than that of the current signer has signed the signature, if YES, proceeding to step 35, and if NO, exiting; and
step 35: determining whether the signature field is a field to be processed by the current signer, if YES, processing and signing the signature, and if NO, hiding the signature field, or not allowing to operate the signature field.

9. An enterprise user-based system for simplifying an electronic signature of a PDF document, comprising:
a client module, used for a user account to log in and acquire a signature style from a server, and used to support signing a signature onto the PDF document by using a signature tool; generate a corresponding document summary after signing the signature, and submit the document summary to the server; and generate a final signed document based on the document summary encrypted with a digital certificate; and
a server module, used for configuring an electronic signature system to link up with an enterprise account system, such that the enterprise user automatically logs in to the electronic signature system of the server after the enterprise user logging in to an operating system; and
used for creating a signature style; and performing digital certificate encryption on the document summary submitted by the signer, and recording a log.

10. An enterprise user-based system for simplifying an electronic signature of a PDF document, comprising:
a client module, used for a user account to log in and acquire a signature style from a server, and used to determine a signature field of a PDF document to be signed, and support signing a signature onto the PDF document in the signature field by using a signature tool; generate a corresponding document summary after signing the signature, and submit the document summary to the server; and generate a final signed document based on the document summary encrypted with a digital certificate; and
a server module, used for configuring an electronic signature system to link up with an enterprise account system, such that the enterprise user automatically logs in to the electronic signature system of the server after the enterprise user logging in to an operating system; creating a signature style; and performing digital certificate encryption on the document summary submitted by the signer, and recording a log; wherein
the client module further includes a form extension module for creating a standard PDF form field, and extending the standard PDF form field.
